(19) United States
(12) Patent Application Publication
(10) Pub. No.: US 2011/0157623 A1
(43) Pub. Date: Jun. 30, 2011

(54) SCREEN IMAGE MANAGEMENT APPARATUS, SCREEN IMAGE MANAGEMENT METHOD, AND COMPUTER READABLE MEDIUM STORING PROGRAM THEREFOR

(75) Inventor: Hidetomo NAKAYAMA, Kanagawa (JP)

(73) Assignee: FUJI XEROX CO., LTD., Tokyo (JP)

(21) Appl. No.: 12/782,426

(22) Filed: May 18, 2010

(30) Foreign Application Priority Data
Dec. 24, 2009 (JP) 2009-291880

(51) Int. Cl. G06F 3/12; G06F 3/048

(52) U.S. Cl. 358/1.15; 715/846

(57) ABSTRACT

A screen image management apparatus includes a screen image obtaining unit, an image attribute obtaining unit, an apparatus attribute obtaining unit, and a determination unit. The screen image obtaining unit obtains a screen image including an icon. The image attribute obtaining unit obtains an image attribute that is an attribute of the icon. The apparatus attribute obtaining unit obtains an apparatus attribute that is an attribute of another apparatus. The determination unit determines whether to display, on the other apparatus, the icon included in the screen image obtained by the screen image obtaining unit, based on the image attribute obtained by the image attribute obtaining unit and the apparatus attribute obtained by the apparatus attribute obtaining unit.

### CROSS-REFERENCE TO RELATED APPLICATIONS

This application is based on and claims priority under 35 USC 119 from Japanese Patent Application No. 2009-291880 filed Dec. 24, 2009.

### BACKGROUND

The present invention relates to a screen image management apparatus, a screen image management method, and a computer readable medium storing a program therefor.

### SUMMARY

According to an aspect of the invention, there is provided a screen image management apparatus including a screen image obtaining unit, an image attribute obtaining unit, an apparatus attribute obtaining unit, and a determination unit. The screen image obtaining unit obtains a screen image including an icon. The image attribute obtaining unit obtains an image attribute that is an attribute of the image. The apparatus attribute obtaining unit obtains an apparatus attribute that is an attribute of another apparatus. The determination unit determines whether to display, on the other apparatus, the image included in the screen image obtained by the screen image obtaining unit, based on the image attribute obtained by the image attribute obtaining unit and the apparatus attribute obtained by the apparatus attribute obtaining unit.

### BRIEF DESCRIPTION OF THE DRAWINGS

Exemplary embodiment(s) of the present invention will be described in detail based on the following figures, wherein:

FIG. 1 is a diagram illustrating the overall configuration of a computer system to which an exemplary embodiment of the present invention is applied;

FIG. 2 is a block diagram illustrating an example of a functional configuration of a virtual desktop server according to the exemplary embodiment of the present invention;

FIG. 3 is a flowchart illustrating an example of an operation of the virtual desktop server performed for a document icon according to the exemplary embodiment of the present invention;

FIG. 4 is a flowchart illustrating an example of an operation of the virtual desktop server performed for a printer icon according to the exemplary embodiment of the present invention;

FIG. 5 is a diagram illustrating an example of virtual desktop information managed by the virtual desktop server according to the exemplary embodiment of the present invention;

FIG. 6 is a diagram illustrating the case where a virtual desktop is displayed on a terminal apparatus intended for use at a fixed location according to the exemplary embodiment of the present invention;

FIG. 7 is a diagram illustrating the case where a virtual desktop is displayed on the terminal apparatus intended for use at a fixed location and an icon attribute is set according to the exemplary embodiment of the present invention;

FIG. 8A is a diagram illustrating an example of document icon attribute information according to the exemplary embodiment of the present invention;

FIG. 8B is a diagram illustrating an example of printer icon attribute information according to the exemplary embodiment of the present invention;

FIG. 9 is a diagram illustrating the case where a virtual desktop is displayed on a portable terminal apparatus according to the exemplary embodiment of the present invention; and

FIG. 10 is a hardware block diagram of a computer capable of realizing the exemplary embodiment of the present invention.

### DETAILED DESCRIPTION

An exemplary embodiment of the present invention will be described in detail with reference to the accompanying drawings.

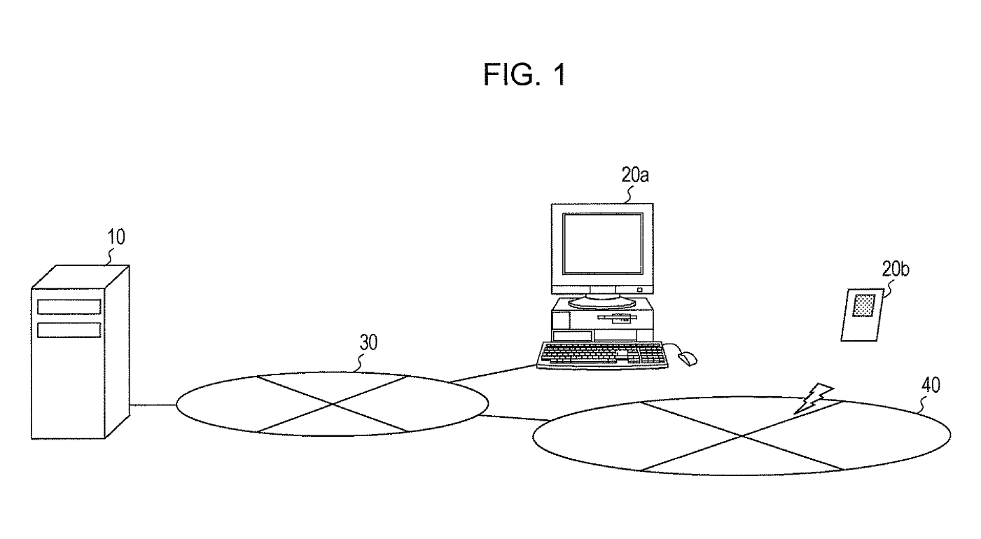

FIG. 1 illustrates an example of a configuration of a computer system to which the exemplary embodiment is applied.

As illustrated in FIG. 1, the computer system includes a virtual desktop server 10, terminal apparatuses 20a and 20b, an in-house local area network (LAN) 30, and the Internet 40.

The virtual desktop server 10 is a server computer that provides a virtual desktop mentioned in cloud computing. That is, the virtual desktop server 10 creates a situation where a desktop (screen image displayed when an operating system (OS) is activated) displayed on the terminal apparatuses 20a and 20b is usable at any location by managing the desktop as a virtual desktop using software such as VMware's Virtual Desktop Infrastructure (VDI) (VMware is a trademark or a registered trademark of VMware, Inc. in the United States and other countries). Here, for example, a personal computer (PC), a workstation, or another computer may be used as the virtual desktop server 10. In the exemplary embodiment, a desktop is used as an example of a screen image, and the virtual desktop server 10 is provided as an example of a screen image management apparatus.

The terminal apparatuses 20a and 20b are computers that display and use a virtual desktop provided by the virtual desktop server 10. Here, the terminal apparatus 20a is a terminal apparatus intended for use at a fixed location, such as a desktop PC. The terminal apparatus 20b is a portable terminal apparatus, such as a mobile phone or a personal digital assistant (PDA). It is assumed that the same user can use both the terminal apparatuses 20a and 20b. Although the terminal apparatuses 20a and 20b are illustrated in FIG. 1, the terminal apparatuses 20a and 20b may be collectively referred to as “terminal apparatuses 20” when it is unnecessary to distinguish between the terminal apparatuses 20a and 20b. Although only the two terminal apparatuses 20 are illustrated in FIG. 1, three or more terminal apparatuses 20 may be provided. In the exemplary embodiment, the terminal apparatuses 20a and 20b are provided as examples of another apparatus.

The in-house LAN 30 is a network that connects in-house computers and printers by using dedicated lines or the like, so that data can be sent and received among these computers and printers. In the exemplary embodiment, the virtual desktop server 10 is connected to the in-house LAN 30. The terminal apparatus 20a is also connected to the in-house LAN 30 and is regarded as being a terminal apparatus that is relatively less restricted in terms of using a virtual desktop.

The Internet 40 is a very large network that connects networks all over the world by using the Transmission Control Protocol/Internet Protocol (TCP/IP). The terminal apparatus 20b is capable of connecting to the Internet 40 via a base station (not illustrated) and is regarded as being a terminal apparatus that is relatively more restricted in terms of using a virtual desktop.

It is assumed that, in such a computer system, the virtual desktop server 10 provides a virtual desktop without taking into consideration the configuration and performance of the terminal apparatuses 20 that use the virtual desktop. As a result, all the icons on the virtual desktop on a desktop PC that has a large and high-resolution display are also displayed on the virtual desktop on a notebook PC at a place away from the user's office. When the user of, for example, a mobile phone that has only a limited user interface (UI) opens the virtual desktop to refer to or print a document file, all the information of the virtual desktop is displayed, and then the user selects the document file, resulting in much lower convenience.

In the exemplary embodiment, the attributes of icons on a virtual desktop are determined from a database in which information of the icons has been registered, and an icon(s) to be displayed is (are) selected from among these icons in accordance with information such as information regarding the type and state (place and connection destination) of a terminal apparatus 20 that uses the virtual desktop. Accordingly, the terminal apparatus 20 is provided with an effective desktop.

The terminal apparatus 20 which realizes such an operation will now be described.

The terminal apparatus 20 includes a sending unit (not illustrated) that sends terminal information to the virtual desktop server 10 when accessing the virtual desktop server 10. The terminal information includes device information such as the resolution (displayable resolution) at which the terminal apparatus 20 can display an image, and environment information such as the operating environment (Fully Qualified Domain Name/Internet Protocol (FQDN/IP) address and Global Positioning System (GPS) information) of the terminal apparatus 20.

Next, the virtual desktop server 10 which realizes the foregoing operation will be described.

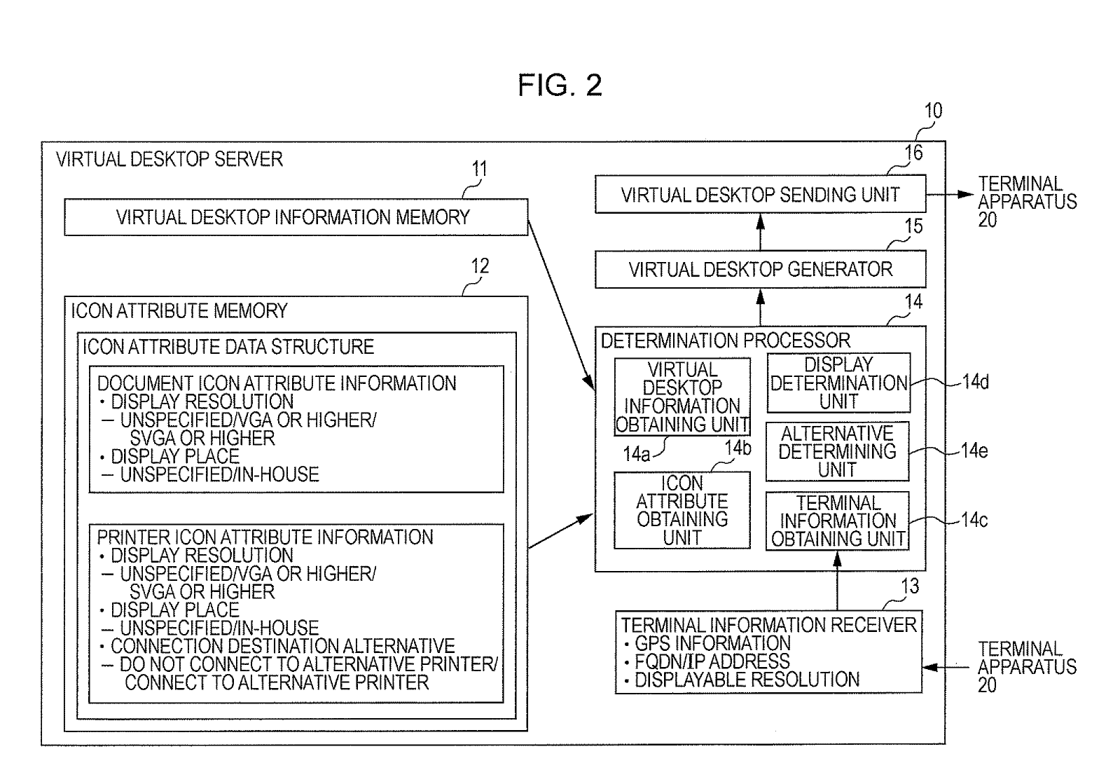

FIG. 2 is a block diagram illustrating an example of a functional configuration of the virtual desktop server 10.

As illustrated in FIG. 2, the virtual desktop server 10 includes a virtual desktop information memory 11, an icon attribute memory 12, a terminal information receiver 13, a determination processor 14, a virtual desktop generator 15, and a virtual desktop sending unit 16.

The virtual desktop information memory 11 stores information regarding a virtual desktop, such as information regarding a user that uses the virtual desktop, and identification information of an icon(s) arranged by that user on the virtual desktop. In the exemplary embodiment, the virtual desktop information memory 11 is provided as an example of a screen image memory that stores a screen image.

The icon attribute memory 12 stores the attributes of an icon arranged on a virtual desktop. Specifically, the icon attribute memory 12 stores a data structure that holds attribute information associated with an icon.

Here, the attributes of an icon include, in the case of a document icon, an attribute regarding a display resolution (display resolution attribute) and an attribute regarding a display place (display place attribute). Of these attributes, one of “unspecified”, “VGA or higher”, and “SVGA or higher” is set as the display resolution attribute. Also, “unspecified” or “in-house” is set as the display place attribute.

The attributes of a printer icon include a display resolution attribute, a display place attribute, and a connection destination alternative attribute. Among these attributes, one of “unspecified”, “VGA or higher”, and “SVGA or higher” is set as the display resolution attribute, and “unspecified” or “in-house” is set as the display place attribute. Also, the connection destination alternative attribute is an attribute that indicates whether to connect to an alternative printer when it is impossible to connect to a printer associated with the printer icon, and “do not connect to alternative printer” or “connect to alternative printer” is set as the connection destination alternative attribute. Alternatively, the range over which an alternative printer is searched for (e.g., “in-house” or “convenience stores”) may be set instead of “connect to alternative printer”. Hereinafter, it is assumed that “connect to alternative printer” is set in order to simplify the description.

In the exemplary embodiment, an icon is used as an example of an image that represents information or a process using a picture or symbol. An icon attribute is used as an example of an image attribute. The icon attribute memory 12 is provided as an example of an image attribute memory that stores an image attribute.

The terminal information receiver 13 receives, from a connection request from the terminal apparatus 20, terminal information including device information unique to the terminal apparatus 20 and environment information regarding an environment in which the terminal apparatus 20 is located. In the exemplary embodiment, terminal information is used as an example of an apparatus attribute. The terminal information receiver 13 is provided as an example of a receiver that receives an apparatus attribute.

The determination processor 14 reads, from the icon attribute memory 12, the attributes of each icon registered in the virtual desktop information memory 11 and determines whether to display, each icon and to change the printer associated with each printer icon to an alternative printer. Specifically, the determination processor 14 includes a virtual desktop information obtaining unit 14a, an icon attribute obtaining unit 14b, a terminal information obtaining unit 14c, a display determination unit 14d, and an alternative determination unit 14e.

The virtual desktop information obtaining unit 14a reads virtual desktop information from the virtual desktop information memory 11. In the exemplary embodiment, the virtual desktop information obtaining unit 14a is provided as an example of a screen image obtaining unit that obtains a screen image.

The icon attribute obtaining unit 14b reads, from the icon attribute memory 12, the attributes of each icon defined by virtual desktop information obtained by the virtual desktop information obtaining unit 14a. In the exemplary embodiment, the icon attribute obtaining unit 14b is provided as an example of an image attribute obtaining unit that obtains an image attribute.

The terminal information obtaining unit 14c obtains terminal information that is received by the terminal information receiver 13 from the terminal apparatus 20. In the exemplary embodiment, the terminal information obtaining unit 14c is provided as an example of an apparatus attribute obtaining unit that obtains an apparatus attribute.

When the display resolution attribute of an icon is other than “unspecified”, the display determination unit 14d compares the displayable resolution of the terminal apparatus 20 with the display resolution of the icon and, when the displayable resolution of the terminal apparatus 20 does not satisfy the display resolution of the icon, determines that the icon is not to be displayed. When the display place attribute of an icon is “in-house”, the display determination unit 14d checks the FQDN/IP address of the terminal apparatus 20. As a result, when it is determined that the terminal apparatus 20 is performing access from an FQDN/IF address outside the in-house LAN 30, the display determination unit 14d determines that the icon is not to be displayed. These determinations are similarly made in the case of a document icon and in the case of a printer icon. In the exemplary embodiment, the display determination unit 14d is provided as an example of a determination unit that determines whether to display an image on another apparatus.

When the connection destination alternative attribute of an icon is “connect to alternative printer”, the alternative determination unit 14e checks the FQDN/IP address of the terminal apparatus 20. As a result, when it is determined that the terminal apparatus 20 is performing access from an FQDN/IP address within the in-house LAN 30, the alternative determination unit 14e searches a subnet thereof for an alternative printer. In contrast, when it is determined that the terminal apparatus 20 is performing access from an FQDN/IP address outside the in-house LAN 30, the alternative determination unit 14e searches for an alternative printer located at a convenience store that is closest to the terminal apparatus 20, based on GPS information of the terminal apparatus 20. When an alternative printer is found, the alternative determination unit 14e generates an icon enabling connection to the alternative printer by using a common driver. In the exemplary embodiment, a process of performing printing with a specific printer is used as an example of a process represented by an image, and a process of performing printing with an alternative printer is used as an example of an alternative process performed instead of that process. The alternative determination unit 14e is provided as an example of a decision unit that decides upon an alternative process.

The virtual desktop generator 15 generates virtual desktop information regarding a virtual desktop in which an icon is displayed which has been determined to be displayed and which has been changed since it has been determined to change to an alternative printer. In the exemplary embodiment, the virtual desktop generator 15 is provided as an example of a generator that generates a new screen image.

The virtual desktop sending unit 16 sends virtual desktop information generated by the virtual desktop generator 15 to the terminal apparatus 20. In the exemplary embodiment, the virtual desktop sending unit 16 is provided as an example of a sending unit that sends a new screen image.

Next, the operation of the exemplary embodiment will be described.

It is assumed in this operation that the terminal information receiver 13 has received and is holding terminal information from the terminal apparatus 20 in response to a connection request from the terminal apparatus 20. Although not illustrated in FIG. 2, it is also assumed that a user ID for identifying the user of the terminal apparatus 20 has also been obtained from the terminal apparatus 20. The virtual desktop information obtaining unit 14a reads, from among items of virtual desktop information stored in the virtual desktop information memory 11, virtual desktop information corresponding to the user of that user ID from the virtual desktop information memory 11. Thereafter, attention is paid to each of icons defined by that virtual desktop information, and processes are performed by the icon attribute obtaining unit 14b, the terminal information obtaining unit 14c, the display determination unit 14d, and the alternative determination unit 14e.

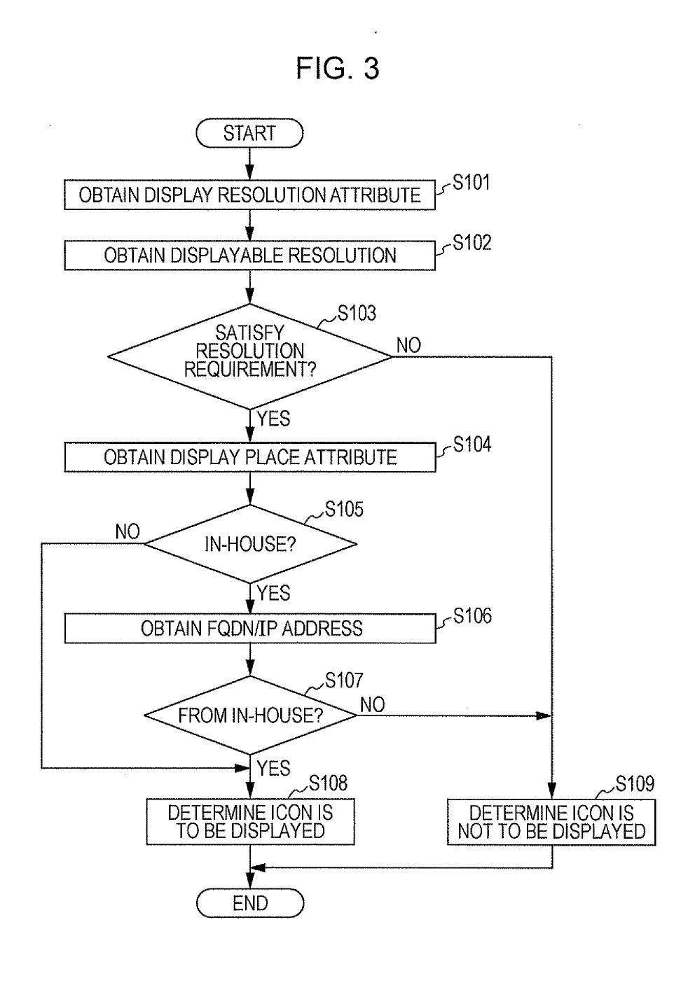

FIG. 3 is a flowchart illustrating an example of an operation of the icon attribute obtaining unit 14b, the terminal information obtaining unit 14c, the display determination unit 14d, and the alternative determination unit 14e, performed for a target icon when the target icon is a document icon.

In this case, in the determination processor 14, the icon attribute obtaining unit 14b first obtains the display resolution attribute of that document icon from the icon attribute memory 12 (step S101).

The terminal information obtaining unit 14c obtains the displayable resolution of the terminal apparatus 20, which has been received and is being held by the terminal information receiver 13 (step S102).

Accordingly, the display determination unit 14d determines whether the displayable resolution obtained by the terminal information obtaining unit 14c in step S102 satisfies a requirement of the display resolution attribute obtained by the icon attribute obtaining unit 14b in step S101 (step S103).

As a result, when it is determined by the display determination unit 14d that the displayable resolution satisfies the requirement of the display resolution attribute, the icon attribute obtaining unit 14b obtains the display place attribute of that document icon from the icon attribute memory 12 (step S104). Accordingly, the display determination unit 14d determines whether the display place attribute is “in-house” (step S105). When the display place attribute is not “in-house”, that is, when the display place attribute is “unspecified”, it is determined that that document icon is to be displayed (step S108). Specifically, identification information of the document icon and information indicating that the document icon is to be displayed may be associated with each other and stored in a memory (not illustrated). When the display place attribute is “in-house”, the terminal information obtaining unit 14c obtains the FQDN/IP address of the terminal apparatus 20 (step S106). Accordingly, the display determination unit 14d determines whether the connection request is from in-house (step S107). When the connection request is from in-house, it is determined that that document icon is to be displayed (step S108). Specifically, identification information of the document icon and information indicating that the document icon is to be displayed may be associated with each other and stored in a memory (not illustrated).

In contrast, when the display determination unit 14d determines in step S103 that the displayable resolution does not satisfy the requirement of the display resolution attribute, or when the display determining unit 14d determines in step S107 that the connection request is not from in-house, the display determination unit 14d determines that the document icon is not to be displayed (step S109). Specifically, identification information of the document icon and information indicating that the document icon is not to be displayed may be associated with each other and stored in a memory (not illustrated).

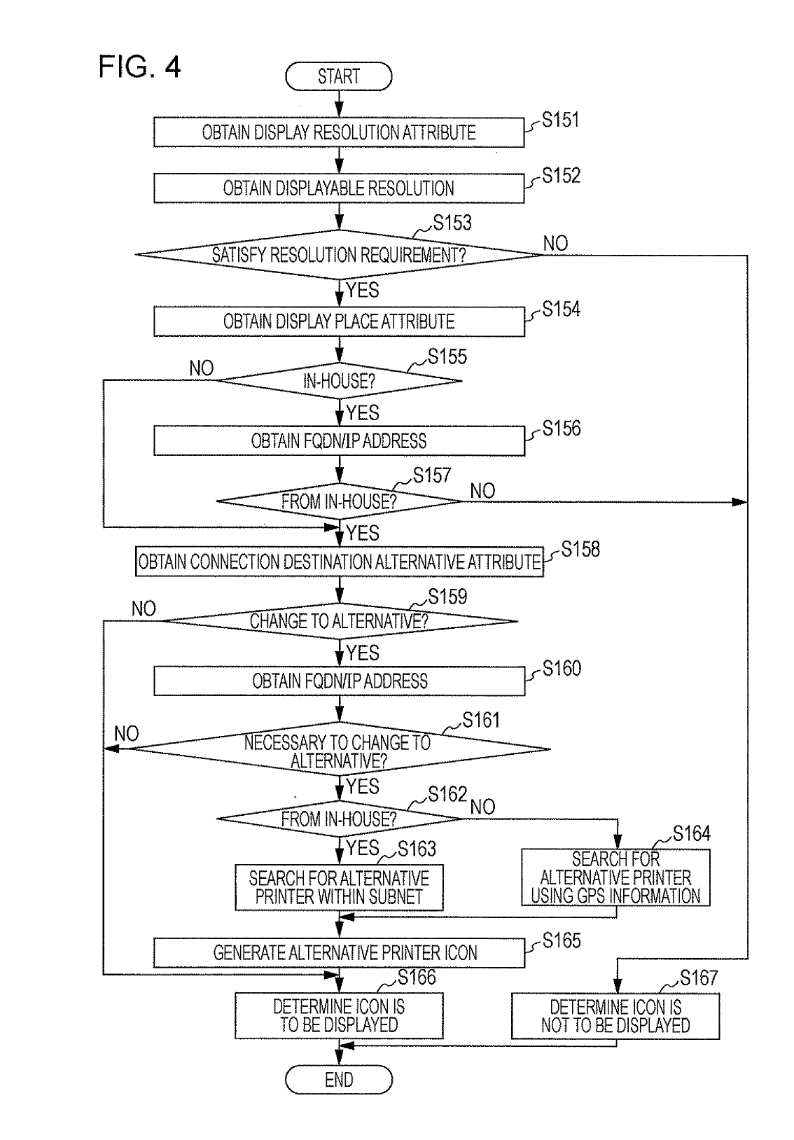

FIG. 4 is a flowchart illustrating an example of an operation of the icon attribute obtaining unit 14b, the terminal information obtaining unit 14c, the display determination unit 14d, and the alternative determination unit 14e, performed for a target icon when the target icon is a printer icon.

In this case, in the determination processor 14, the icon attribute obtaining unit 14b first obtains the display resolution attribute of that printer icon from the icon attribute memory 12 (step S151).

The terminal information obtaining unit 14c obtains the displayable resolution of the terminal apparatus 20, which has been received and is being held by the terminal information receiver 13 (step S152).

Accordingly, the display determination unit 14d determines whether the displayable resolution obtained by the terminal information obtaining unit 14c in step S152 satisfies a requirement of the display resolution attribute obtained by the icon attribute obtaining unit 14b in step S151 (step S153).

As a result, when it is determined by the display determination unit 14d that the displayable resolution satisfies the requirement of the display resolution attribute, the icon attribute obtaining unit 14b obtains the display place attribute of that printer icon from the icon attribute memory 12 (step S154). Accordingly, the display determination unit 14d determines whether the display place attribute is “in-house” (step S155). When the display place attribute is not “in-house”, that is, when the display place attribute is “unspecified”, control is then performed by the alternative determination unit 14e. When the display place attribute is “in-house”, the terminal information obtaining unit 14c obtains the FQDN/IP address of the terminal apparatus 20 (step S156). Accordingly, the display determination unit 14d determines whether the connection request is from in-house (step S157). When the connection request is from in-house, control is then performed by the alternative determination unit 14e.

Next, the alternative determination unit 14e obtains the connection destination alternative attribute of that printer icon from the icon attribute memory 12 (step S158). Accordingly, the alternative determination unit 14e determines whether the connection destination alternative attribute is set as “do not connect to alternative printer” (step S159).

As a result, when the connection destination alternative attribute is set as “do not connect to alternative printer”, a printer associated with the printer icon is not changed to an alternative printer, and the display determination unit 14d determines that the printer icon is to be displayed (step S166). Specifically, identification information of the printer icon and information indicating that the printer icon is to be displayed may be associated with each other and stored in a memory (not illustrated).

In contrast, when the connection destination alternative attribute is not set as “do not connect to alternative printer”, that is, when the connection destination alternative attribute is set as “connect to alternative printer”, the terminal information obtaining unit 14c obtains the FQDN/IP address of the terminal apparatus 20 (step S160). Accordingly, the alternative determination unit 14e determines, based on the FQDN/IP address, whether the terminal apparatus 20 is incapable of performing printing with a printer that has been associated beforehand with the printer icon, and it is thus necessary to replace the connection destination (step S161). When it is determined that it is necessary to replace the connection destination, the display determination unit 14d determines whether the connection request is from in-house (step S162). When the connection request is from in-house, the alternative determination unit 14e searches the subnet for an alternative printer (step S163). When the connection request is not from in-house, the alternative determination unit 14e searches for an alternative printer located at, for example, a convenience store that is close to the terminal apparatus 20, by using GPS information obtained by the terminal information obtaining unit 14c (step S164). When an alternative printer is found in this manner, the alternative determination unit 14e generates an icon for the alternative printer by using a common driver (step S165). Thereafter, the display determination unit 14d determines that the printer icon is to be displayed (step S166). Specifically, identification information of the printer icon and information indicating that the printer icon is to be displayed may be associated with each other and stored in a memory (not illustrated).

In contrast, when the display determining unit 14d determines in step S153 that the displayable resolution does not satisfy the requirement of the display resolution attribute, or when the display determination unit 14d determines in step S157 that the connection request is not from in-house, the display determination unit 14d determines that the printer icon is not to be displayed (step S167). Specifically, identification information of the printer icon and information indicating that the printer icon is not to be displayed may be associated with each other and stored in a memory (not illustrated).

Next, the exemplary embodiment will be described in more detail using a specific example.

First, information managed by the virtual desktop server 10 will be described.

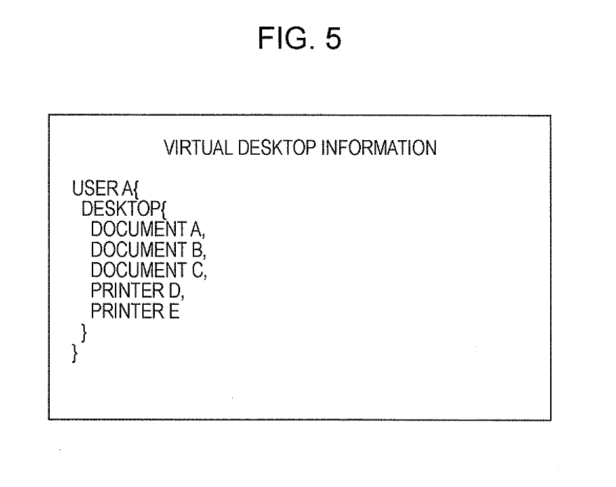

FIG. 5 illustrates a specific example of virtual desktop information stored in the virtual desktop information memory 11. In this virtual desktop information, it is defined that the user of a virtual desktop is a user A, and document icons representing documents A, B, and C and printer icons representing printers D and E are arranged on the virtual desktop.

The user establishes a connection from the terminal apparatus 20a connected to the in-house LAN 30 (see FIG. 1) to the virtual desktop server 10 and causes the virtual desktop to be displayed.

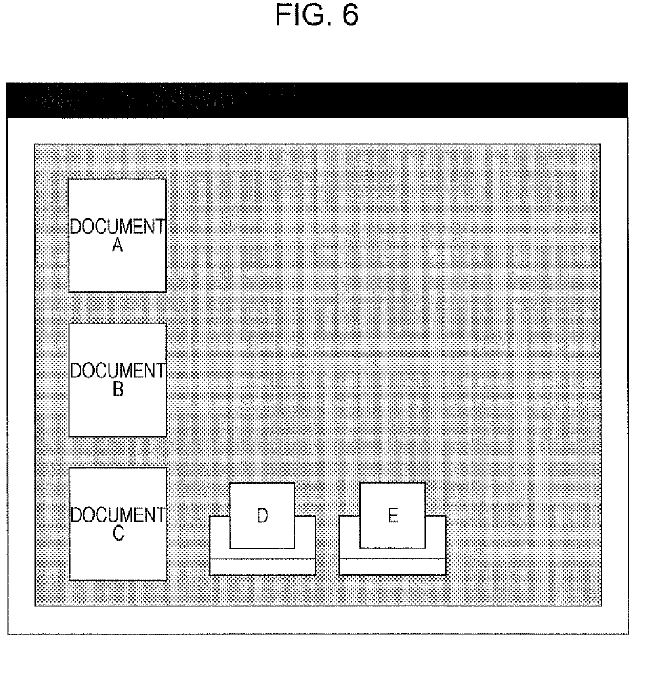

FIG. 6 is a diagram illustrating an example of the virtual desktop displayed at this time.

In accordance with the definitions in the virtual desktop information illustrated in FIG. 5, document icons representing the documents A, B, and C and printer icons representing the printers D and E are displayed.

Next, the case where the user sets an attribute of an icon will be described.

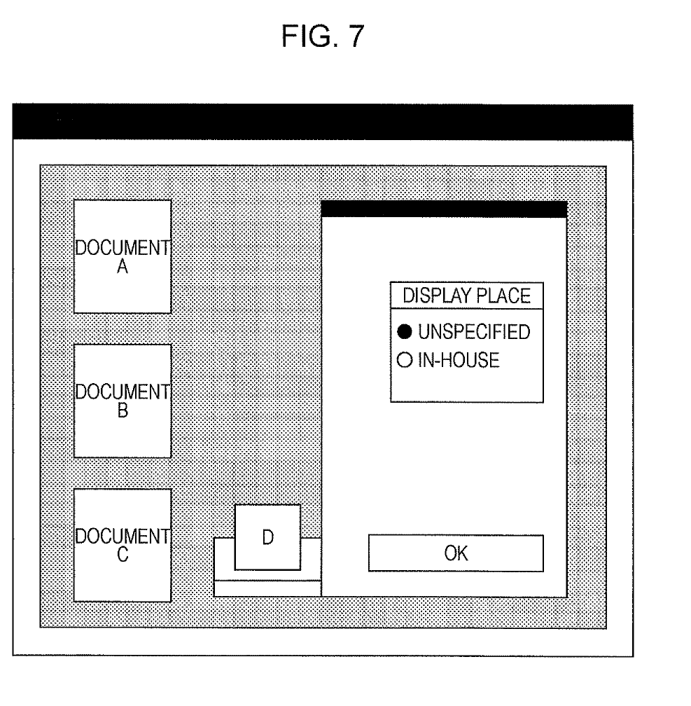

FIG. 7 illustrates an example of a virtual desktop when the user sets an attribute of an icon.

In the diagram, a dialog box for setting a display place attribute is displayed over the printer icon E. When “unspecified” is checked as the display place attribute as illustrated in FIG. 7 and an “OK” button is pressed, “unspecified” is set as the display place attribute of the printer icon representing the printer E.

Similarly, it is assumed that attributes of icons including the document icons representing the documents A, B, and C and the printer icon representing the printer 0, and the remaining attributes of the printer icon representing the printer E have been set.

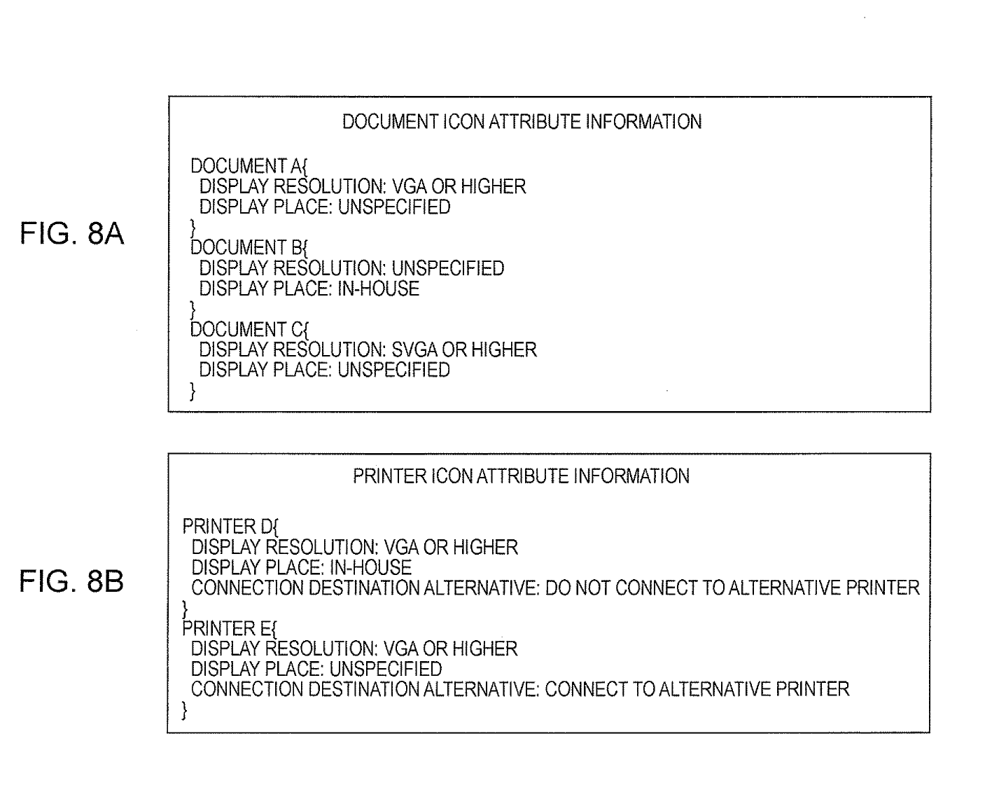

FIGS. 8A and 8B illustrate examples of attributes of icons stored in the icon attribute memory 12 of the virtual desktop server 10 as a result of such setting operations.

FIG. 8A illustrates an example of attribute information of the document icons.

As illustrated in FIG. 8A, “VGA or higher” is set as the display resolution attribute and “unspecified” as the display place attribute of the document icon representing the document A. Also, “unspecified” is set as the display resolution attribute and “in-house” as the display place attribute of the document icon representing the document B. Further, “SVGA or higher” is set as the display resolution attribute and “unspecified” as the display place attribute of the document icon representing the document C.

FIG. 8B illustrates an example of attribute information of the printer icons.

As illustrated in FIG. 8B, “VGA or higher” is set as the display resolution attribute and “in-house” as the display place attribute of the printer icon representing the printer D. Although not illustrated in FIG. 8B, “129.249.219.10” is set as a connection destination of the printer icon. Also, “do not connect to alternative printer” is set as the connection destination alternative attribute. This indicates that, even if printing with a printer at this connection destination cannot be performed, printing with an alternative printer is not to be performed. Also, “VGA or higher” is set as the display resolution attribute and “unspecified” as the display place attribute of the printer icon representing the printer E. Although not illustrated in FIG. 8B, “129.249.219.12” has been set in advance as a connection destination of the printer icon. Also, “connect to alternative printer” is set as the connection destination alternative attribute. This indicates that, if printing with a printer at this connection destination cannot be performed, printing with an alternative printer is to be performed.

It is assumed that, in this state, the user uses the terminal apparatus 20b such as a mobile phone at a place away from the user's office to connect to the virtual desktop server 10 and to cause a virtual desktop to be displayed.

When sending the user ID to the virtual desktop server 10, the terminal apparatus 20b sends the displayable resolution, FQDN/IP address, and GPS information of the terminal apparatus 20b. Here, it is assumed that “VGA” is sent as the displayable resolution, “xxx.yyy.ne.jp” which is FQDN outside the user's office is sent as the FQDN/IP address, and “N-45.224, E-137.001” which is the latitude and the longitude outside the user's office is sent as the GPS information.

The virtual desktop server 10 which has accepted a connection request from the terminal apparatus 20b obtains icon information of each icon on the user's virtual desktop.

The virtual desktop server 10 compares the displayable resolution and the FON/IP address received from the terminal apparatus 20b with the display resolution attribute and the display place attribute of each icon, and determines whether to display each icon.

The results of determinations on the document icons are as follows.

That is, since the displayable resolution of the terminal apparatus 20b satisfies a requirement of the display resolution attribute of the document icon representing the document A and the FQDN/IP address of the terminal apparatus 20b satisfies a requirement of the display place attribute of this icon, this icon is to be displayed.

In contrast, although the displayable resolution of the terminal apparatus 20b satisfies a requirement of the display resolution attribute of the document icon representing the document B, because the FQDN/IP address of the terminal apparatus 20b is “outside the office” and does not satisfy a requirement of the display place attribute of this icon, this icon is not to be displayed.

Also, although the FQDN/IP address of the terminal apparatus 20b satisfies a requirement of the display place attribute of the document icon representing the document C, because the displayable resolution of the terminal apparatus 20b is “VGA” and does not satisfy a requirement of the display resolution attribute of this icon, this icon is not to be displayed.

Similarly, the results of determinations on the printer icons are as follows.

That is, although the displayable resolution of the terminal apparatus 20b satisfies a requirement of the display resolution attribute of the printer icon representing the printer D, because the FQDN/IP address of the terminal apparatus 20b is “outside the office” and does not satisfy a requirement of the display place attribute of this icon, this icon is not to be displayed.

In contrast, since the displayable resolution of the terminal apparatus 20b satisfies a requirement of the display resolution attribute of the printer icon representing the printer E and the FQDN/IP address of the terminal apparatus 20b satisfies a requirement of the display place attribute of this icon, this icon is to be displayed. With regard to this icon, an alternative printer is searched for, based on the latitude and the longitude “N-45.224, E-137.001”, from among, for example, printers located at convenience stores, and address information of this alternative printer is set.

Thereafter, the virtual desktop server 10 generates virtual desktop information indicating a virtual desktop including the document icon representing the document A and the printer icon representing the printer E, and sends the virtual desktop information to the terminal apparatus 20b.

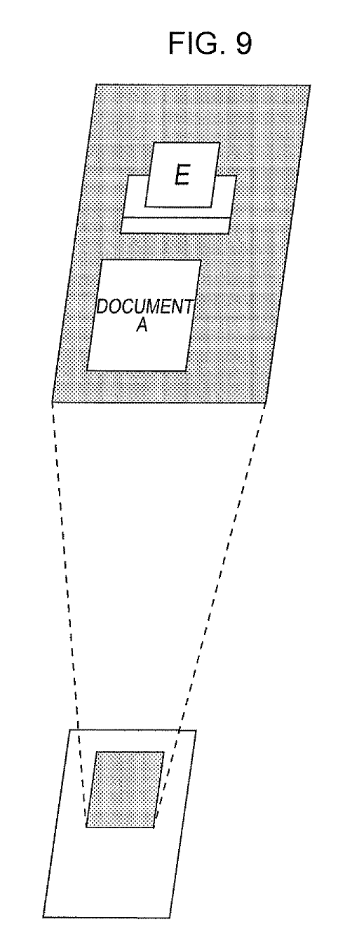

FIG. 9 illustrates a virtual desktop displayed on the terminal apparatus 20b in this manner.

As illustrated in FIG. 9, only the document icon representing the document A and the printer icon representing the printer E are arranged on the virtual desktop.

Therefore, the user performs printing using a general service such as convenience-store printing by dragging the icon representing the document A to the icon representing the printer E.

Although the virtual desktop server 10 performs processes to store, change, and send a virtual desktop in the exemplary embodiment, these processes may be performed by individual computers.

The hardware configuration of a computer 90 serving as the virtual desktop server 10 and the individual computers will now be described.

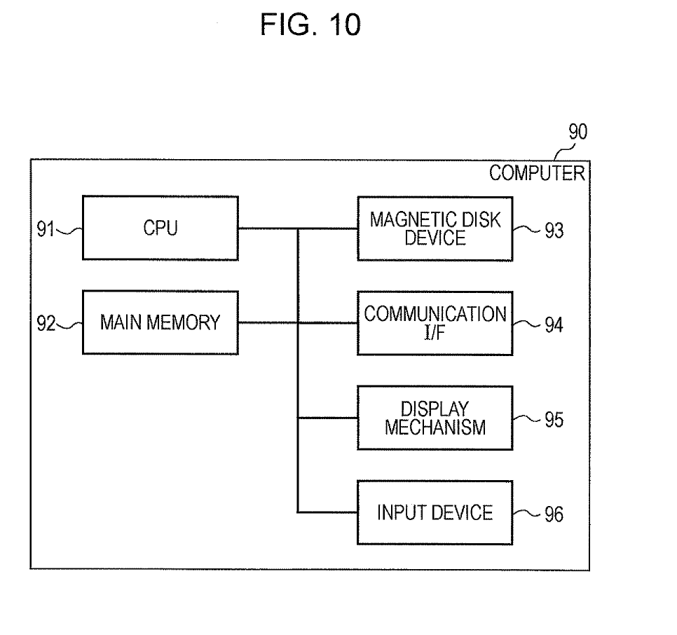

FIG. 10 is a diagram illustrating the hardware configuration of the computer 90.

As illustrated in FIG. 10, the computer 90 includes a central processing unit (CPU) 91 serving as an arithmetic unit, and a main memory 92 and a magnetic disk device (hard disk drive or HDD) 93 serving as a memory. The CPU 91 executes various pieces of software including an operating system (OS) and applications, and realizes the above-described functions. The main memory 92 is a storage area that stores various pieces of software and data used in executing these pieces of software. The magnetic disk device 93 is a storage area that stores input data for various pieces of software and output data from these pieces of software.

The computer 90 further includes a communication interface (I/F) 94 for performing communication with the outside, a display mechanism 95 including a video memory and a display, and an input device 96 including a keyboard and a mouse.

A program that realizes the exemplary embodiment may be provided by a communication unit or may be stored on a storage medium such as a compact disc read-only memory (CD-ROM) and provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is Claimed is:

1. A screen image management apparatus comprising:
a screen image obtaining unit that obtains a screen image including an icon;
an image attribute obtaining unit that obtains an image attribute that is an attribute of the icon;
an apparatus attribute obtaining unit that obtains an apparatus attribute that is an attribute of another apparatus; and
a determination unit that determines whether to display, on the other apparatus, the icon included in the screen image obtained by the screen image obtaining unit, based on the image attribute obtained by the image attribute obtaining unit and the apparatus attribute obtained by the apparatus attribute obtaining unit.

2. The screen image management apparatus according to claim 1, wherein the determination unit determines whether to display the icon on the other apparatus, based on the image attribute, the image attribute being an image attribute regarding a place where the icon is to be displayed, and the apparatus attribute, the apparatus attribute being an apparatus attribute regarding a place where the other apparatus exists.

3. The screen image management apparatus according to claim 1, wherein the determination unit determines whether to display the icon on the other apparatus, based on the image attribute, the image attribute being an image attribute regarding a display resolution of the icon, and the apparatus attribute, the apparatus attribute being an apparatus attribute regarding a displayable resolution of the other apparatus.

4. The screen image management apparatus according to claim 1, further comprising a decision unit that decides upon an alternative process to be performed instead of a process represented by the icon included in the screen image obtained by the screen image obtaining unit, based on the apparatus attribute obtained by the apparatus attribute obtaining unit.

5. The screen image management apparatus according to claim 4, wherein the decision unit decides upon the alternative process based on the apparatus attribute, the apparatus attribute being an apparatus attribute regarding a place where the other apparatus exists.

6. The screen image management apparatus according to claim 4, wherein the process represented by the icon is a process of performing printing with a specific printer, and
wherein the alternative process is a process of performing printing with an alternative printer that serves as a substitute for the specific printer.

7. A screen image management apparatus comprising:
a screen image memory that stores a screen image including an icon;
an image attribute memory that stores an image attribute that is an attribute of the icon;
a receiver that receives an apparatus attribute that is an attribute of another apparatus from the other apparatus;
a determination unit that determines whether to display, on the other apparatus, the icon included in the screen image stored in the screen image memory, based on the image attribute stored in the image attribute memory and the apparatus attribute received by the receiver;
a generator that generates a new screen image by processing the screen image stored in the screen image memory in accordance with a determination result obtained by the determination unit; and
a sending unit that sends the new screen image generated by the generator to the other apparatus.

8. A screen image management apparatus comprising:
an accepting unit that accepts a request from another apparatus for using a screen image including an icon; and
a sending unit that sends the screen image to the other apparatus without changing the screen image when the other apparatus exists at a first place, and, when the other apparatus exists at a second place, sends, to the other apparatus, a new screen image generated by processing the screen image in accordance with a result of determination whether the icon included in the screen image is to be displayed on the other apparatus.

9. A computer readable medium storing a program causing a computer to execute a process, the process comprising:
obtaining a screen image including a plurality of icons;
obtaining image attributes that are attributes of the plurality of icons;
obtaining an apparatus attribute that is an attribute of another apparatus; and
determining whether to display, on the other apparatus, the plurality of icons included in the screen image, based on the image attributes and the apparatus attribute.

10. A screen image management method comprising:
obtaining a screen image including an icon;
obtaining an image attribute that is an attribute of the icon;
obtaining an apparatus attribute that is an attribute of another apparatus; and
determining whether to display, on the other apparatus, the icon included in the obtained screen image, based on the image attribute and the apparatus attribute.

11. A screen image management method comprising:
storing a screen image including an icon;
storing an image attribute that is an attribute of the icon;
receiving an apparatus attribute that is an attribute of another apparatus from the other apparatus;
determining whether to display, on the other apparatus, the icon included in the screen image, based on the image attribute and the apparatus attribute;
generating a new screen image by processing the screen image in accordance with a determination result; and
sending the new screen image to the other apparatus.

12. A screen image management method comprising:
accepting a request from another apparatus for using a screen image including an icon; and
sending the screen image to the other apparatus without changing the screen image when the other apparatus exists at a first place, and, when the other apparatus exists at a second place, sending, to the other apparatus, a new screen image generated by processing the screen image in accordance with a result of determination whether the icon included in the screen image is to be displayed on the other apparatus.
